(19) United States
(12) Patent Application Publication
(10) Pub. No.: US 2022/0185592 A1
(43) Pub. Date: Jun. 16, 2022

(54) PROTECTION DEVICE FOR BELT CONVEYOR

(71) Applicant: HUANENG POWER INTERNATIONAL, INC. SHANGHAI SHIDONGKOU FIRST POWER PLANT, Shanghai (CN)

(72) Inventors: Zhong Ni, Shanghai (CN); Zhiwei Sang, Shanghai (CN); Xin Hu, Shanghai (CN); Ping Zhu, Shanghai (CN); Xiao Zhang, Shanghai (CN); Jinxin Yu, Shanghai (CN); Haifeng Guan, Shanghai (CN); Jialei Deng, Shanghai (CN); Hongbin Li, Shanghai (CN); Ding Yu, Shanghai (CN); Jianhua Ding, Shanghai (CN)

(21) Appl. No.: 17/237,024

(22) Filed: Apr. 21, 2021

(30) Foreign Application Priority Data
Dec. 16, 2020 (CN) 202011487474.5

(51) Int. Cl. B65G 43/02; B65G 45/12

(52) U.S. Cl. CPC B65G 43/02; B65G 2203/0266; B65G 45/12

(57) ABSTRACT

The present invention relates to a protection device for a belt conveyor. The protection device is arranged on a return conveyor belt, the protection device includes a rotation shaft, a foreign matter barrier plate and a rotation triggering mechanism, the rotation shaft being fixedly connected to a frame of the belt conveyor, the foreign matter barrier plate being vertically arranged, a top of the foreign matter barrier plate being fixedly connected to the rotation shaft, a bottom of the foreign matter barrier plate and the return conveyor belt being arranged at an interval, the rotation triggering mechanism being fixedly connected to the rotation shaft, and the foreign matter barrier plate driving the rotation shaft to rotate, and driving the rotation triggering mechanism to operate when the device is used.

### BACKGROUND OF THE INVENTION

### 1. Field of the Invention

The present invention relates to a protection device, and more particularly, to a protection device for a belt conveyor.

### 2. Description of the Prior Art

A belt conveyor is a common apparatus for conveying materials, the materials falling on a material receiving point of the tail of the belt conveyor are conveyed to a transmission roller of the head through a conveyor belt, and the conveyor belt conveying the materials are diverted at a bent pulley of the tail so as to achieve the function of continuous conveying.

In the operation process of the belt conveyor, it is inevitable that materials or apparatus parts and various foreign matters fall on the return conveyor belt and move towards the bent pulley of the tail. Although the belt conveyor is equipped with a return belt cleaner, part of materials or foreign matters can still penetrate the return belt cleaner, and finally roll into the position between the bent pulley of the tail, so as to cause the conveyor belt to deviate or be damaged. In addition, there was a casualty of an operator rolling into and clamped by the position between the conveyor belt and the bent pulley of the tail during operation.

Under normal condition, when the belt conveyor conveys the materials, only a small quantity of small particles exist on the return conveyor belt, and are cleaned up by the return belt cleaner equipped of the belt conveyor, which can guarantee the return belt is clean upon rolling into the bent pulley of the tail. The conveyor belt exerts uniform force on the surface of the bent pulley of the tail, and if the bent pulley of the tail and the conveyor belt are in normal condition, the conveyor belt can normally operate stably, and may not deviate.

However, the belt conveyor may have several abnormal conditions below during use:

1. when the belt conveyor faces special condition, and the conveyor belt has large flow during operation, the conveyor belt may have abnormal conditions of heavy deviation, etc. when carrying the materials, a large quantity of materials may fall on the return belt consequently, and are conveyed to the tail of the belt conveyor, the return belt cleaner equipped of the belt conveyor cannot clean up these materials, so part of materials may be caused to roll into the position between the conveyor belt and the bent pulley of the tail. Since more and more rolled-into materials are accumulated at the pulley of the tail, interaction force between the conveyor belt and the bent pulley of the tail become uneven in the case of material rolling-into. In addition, a rotation radius of the conveyor belt is greater than a diameter of the pulley, so the conveyor belt violently rubs against a frame of the belt conveyor, and even deviates towards one side of the pulley, and tilts to one side, which may heavily damage the belt conveyor apparatus;

2. when the conveyor belt has a longitudinal tear fault during operation, conveyed materials can fall on the return belt from middle of the torn conveyor belt, or the conveyor belt is overlapped or becomes narrow after being torn, a normal material conveying quantity cannot be borne, a large quantity of materials may fall on the return belt consequently then, and are conveyed to the tail of the belt conveyor. Since the cleaning capacity of the return belt cleaner is limited, the materials roll into the position between the conveyor belt and the bent pulley of the tail after passing through the return belt cleaner;

3. when the parts on the belt conveyor fall on the return conveyor belt, or the foreign matters (for example metal articles, maintenance tools, waste, various impurities, etc.) fall on the return conveyor belt, it is difficult for the return belt cleaner arranged at the tail to clean these articles out of the belt conveyor since these matters are irregular in shape. So these matters can always penetrate the return belt cleaner to be conveyed, by the return conveyor belt, to the bent pulley of the tail, which easily result in that the conveyor apparatus is damaged and cannot operate normally; and

4. the bent pulley of the tail of the belt conveyor is always provided with more apparatuses, so different kinds of workers always perform different kinds of operation at such position when the belt conveyor operates, it becomes possible for the workers or the tools to roll into the position between the return belt and the bent pulley of the tail, so as to cause accidents of personal injuries or damage to the apparatuses, which occurred in many cases applying the belt conveyor.

### SUMMARY OF THE INVENTION

The present invention provides a protection device for a belt conveyor for solving above drawbacks.

According to the claimed invention, a protection device for a belt conveyor includes a frame, a transmission roller, a bent pulley and a conveyor belt sleeved on the transmission roller and the bent pulley, a conveyor belt located at a bottom of the bent pulley being a return conveyor belt, and a conveyor belt located at a top of the bent pulley being a going conveyor belt. The protection device is arranged on the return conveyor belt and before the bent pulley of a tail, the protection device includes a rotation shaft, a foreign matter barrier plate and a rotation triggering mechanism, the rotation shaft being fixedly connected to the frame of the belt conveyor, the foreign matter barrier plate being vertically arranged, a top of the foreign matter barrier plate being fixedly connected to the rotation shaft, a bottom of the foreign matter barrier plate and the return conveyor belt being arranged at an interval, the rotation triggering mechanism being fixedly connected to the rotation shaft, and the foreign matter barrier plate driving the rotation shaft to rotate, and driving the rotation triggering mechanism to operate when the device is used.

Preferably, the protection device further includes a mechanical limit block configured to limit a rotation angle of the foreign matter barrier plate, the mechanical limit block being fixedly connected to the frame of the belt conveyor, the mechanical limit block being arranged on the return conveyor belt, Preferably, the protection device further includes a mechanical limit block configured to limit a rotation angle of the foreign matter barrier plate, the mechanical limit block being fixedly connected to the frame of the belt conveyor, the mechanical limit block being arranged on the return conveyor belt,

Preferably, the rotation triggering mechanism further includes a hammer block, a hammer arm, a hammer frame and a triggering sensor, one end of the hammer arm being fixedly connected to the rotation shaft, the other end being fixedly connected to the hammer block, the hammer frame and the triggering sensor being fixedly connected to the frame of the belt conveyor, a bottom of the hammer arm abutting against the hammer frame, and the hammer arm rotating around the rotation shaft and triggering the triggering sensor when the device is used.

Preferably, the rotation triggering mechanism further includes a sensor holder configured to fix the triggering sensor and limit a rotation angle of the hammer arm, the triggering sensor being arranged on the sensor holder, the hammer arm rotates, under the action of a hammer, around the rotation shaft and abuts against the sensor holder, so as to fix a position of the foreign matter barrier plate, and avoid malfunction under the action of mechanical vibration or light external force or produced by impact of a small quantity of materials.

Preferably, a weight of the hammer may be adjusted according to needs.

Preferably, the triggering sensor is a proximity sensor.

Preferably, the protection device is arranged close to the bent pulley, and the protection device further includes a material accumulation plate, a bottom of the material accumulation plate being fixedly connected to the rotation shaft.

Preferably, the material accumulation plate includes a tilt plate and a vertical plate, the tilt plate being arranged titled to the bent pulley, a bottom of the tilt plate being fixedly connected to a top of the rotation shaft, a top of the tilt plate being fixedly connected to a bottom of the vertical plate, and a top of the vertical plate and the going conveyor belt being arranged at an interval.

Preferably, the rotation shaft includes a rotation shaft body, two rotation bearings and two bearing supports, the bearing support being fixedly arranged on the frame of the belt conveyor, the rotation bearing being fixedly arranged on the bearing support, and two ends of the rotation shaft body being rotatably connected to the two rotation bearings separately.

Preferably, a gap between the bottom of the foreign matter barrier plate and the return conveyor belt is 2-3 cm.

Preferably, a gap between a top of the material accumulation plate and the going conveyor belt is 2-3 cm.

Preferably, a gap between the joint of the vertical plate and the tilt plate and the surface of a pulley body of the bent pulley is 3-5 cm.

Compared with the prior art, the present invention has the following advantages:

(1) by utilizing cooperation among the rotation shaft, the foreign matter barrier plate and the rotation triggering mechanism above the return conveyor belt, the present invention may control the belt conveyor to be stopped before relatively large foreign matters enter the bent pulley, thereby effectively coping with the condition of more and relatively large foreign matters entering the return conveyor belt, and effectively preventing and avoiding damage to the apparatus and personal injuries;

(2) the mechanical limit block arranged by the present invention may limit a rotation angle of the foreign matter barrier plate, and prevent the condition that the material further moves due to inertia after the belt conveyor stops, so as to damage the apparatus and injury workers, thereby improving reliability of the device;

(3) the present invention utilizes the barrier plate and the material accumulation plate to detect a material on the return belt, so as to detect condition of the conveyor belt, and when the conveyor belt is longitudinally torn or in an abnormal state, a large quantity of conveyed materials conveyed to the return belt may be detected in time when falling on the return belt, such that stop may be performed in time, thereby effectively shortening torn and damaged lengths of the conveyor belt, and reducing maintenance cost;

(4) the present invention utilizes the material accumulation plate to make a small quantity of materials, passing through the foreign matter barrier plate, roll into the bent pulley back and forth and are continuously accumulated, when an accumulation quantity of the small quantity of materials influences normal operation of the belt conveyor, impact force generated by the materials may drive the material accumulation plate to rotate, such that the triggering mechanism triggers stop of the belt conveyor; and in addition, some relatively small but relatively-large-mass metal articles may pass through the foreign matter barrier plate, whose impact force generated may drive the material accumulation plate to rotate as well, thereby preventing the materials and the small foreign matters from damaging the belt conveyor, in addition, stop of the device may not be triggered by the condition that only a small quantity of small materials exist on the return belt, thereby effectively coping with influence of the small materials free of accumulation on the belt conveyor, and expanding an application scope of the present invention;

(5) the material accumulation plate of the present invention includes the tilt plate and the vertical plate, the vertical plate is closer to the bent pulley, thereby improving the material accumulation effect and improving detection sensitivity;

(6) the foreign matter barrier plate and the return conveyor belt of the present invention are arranged at an interval, the top of the vertical plate and the going conveyor belt are arranges at an interval, thereby preventing the condition that the conveyor belt is of disturbance when the belt conveyor operates, so as to influence the protection device, and cause error stop; and

(7) the present invention is arranged between the return conveyor belt and the going conveyor belt and close to the position of the bent pulley of the tail, and the protection device itself may prevent a worker from rolling into and being clamped by the apparatus, and still has a protection function even if the protection device is powered off.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a solid structure of the present invention.

FIG. 2 is a schematic diagram of a side surface of the present invention.

### DETAILED DESCRIPTION

The present invention will be described in details below with reference to accompanying drawings and in conjunction with particular embodiments. It should be noted that description of the following embodiments is merely substantial illustration, the present invention does not intend to limit an applicable object or a purpose thereof, and the present invention is not limited to the following embodiments.

### Embodiment 1

A belt conveyor includes a frame, a drive mechanism driving the belt conveyor to operate, a transmission roller, a bent pulley 1 and a conveyor belt sleeved on the transmission roller and the bent pulley 1, a conveyor belt which is located at a bottom of the bent pulley 1, and moves in a direction opposite a material conveying direction is a return conveyor belt 3, and a conveyor belt located at a top of the bent pulley 1 is a going conveyor belt 2.

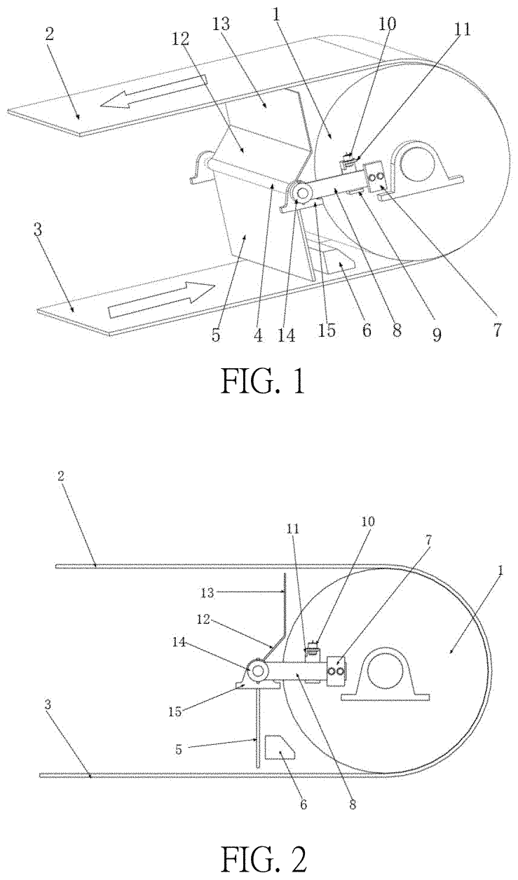

The present invention provides, for the belt conveyor, a protection device for the belt conveyor, as shown in FIGS. 1-2. The protection device is arranged on the return conveyor belt 3, the protection device includes a rotation shaft 4, a foreign matter barrier plate 5 and a rotation triggering mechanism, the rotation shaft 4 being fixedly connected to a frame of the belt conveyor, the foreign matter barrier plate 5 being vertically arranged, a top of the foreign matter barrier plate 5 being fixedly connected to the rotation shaft 4, a bottom of the foreign matter barrier plate 5 and the return conveyor belt 3 being arranged at an interval, and the rotation triggering mechanism being fixedly connected to the rotation shaft 4.

In order to prevent the conveyor belt shakes during operation to come into contact with the foreign matter barrier plate 5, and prevent the protection device from influencing the conveyor belt, the bottom of the foreign matter barrier plate 5 and the return conveyor belt 3 are arranged at an interval, and particularly, a gap between the bottom of the foreign matter barrier plate 5 and the return conveyor belt 3 is 2-3 cm.

In this embodiment, to prevent the foreign matter barrier plate 5 from excessively diverting, the protection device further includes a mechanical limit block 6 configured to limit a rotation angle of the foreign matter barrier plate 5, the mechanical limit block 6 being fixedly connected to the frame of the belt conveyor, the mechanical limit block 6 being arranged on the return conveyor belt 3, and the foreign matter barrier plate 5 rotating around the rotation shaft 4 to abut against the mechanical limit block 6 when the device is used.

When the protection device of this embodiment is used, if a foreign matter appears on the return conveyor belt 3, the foreign matter barrier plate 5 and the rotation shaft 4 are driven to rotate, the rotation triggering mechanism is driven to operate as well, and the foreign matter barrier plate 5 rotates by a certain degree to abut against the mechanical limit block 6.

The rotation triggering mechanism of this embodiment is connected to a control mechanism of the belt conveyor, and the rotation triggering mechanism controls the belt conveyor to stop after operation.

In this embodiment, as for a particular structure of the rotation shaft 4, the rotation shaft 4 includes a rotation shaft body, two rotation bearings 14 and two bearing supports 15, the bearing support 15 being fixedly arranged on the frame of the belt conveyor, the rotation bearing 14 being fixedly arranged on the bearing support 15, and two ends of the rotation shaft body being rotatably connected to the two rotation bearings 14 separately.

### Embodiment 2

As a difference between this embodiment of embodiment 1, a rotation triggering mechanism particularly includes a hammer block 7, a hammer arm 8, a hammer frame 9 and a triggering sensor 10, one end of the hammer arm 8 being fixedly connected to a rotation shaft 4, the other end being fixedly connected to the hammer block 7, the hammer frame 9 and the triggering sensor 10 being fixedly connected to a frame of a belt conveyor, and a bottom of the hammer arm 8 abutting against the hammer frame 9.

A weight of the hammer block 7 may be adjusted on the basis of the material conveying condition, actual working condition on site, and a particular structure of the belt conveyor, so as to improve detection sensitivity and prevent error triggering.

In this embodiment, the triggering sensor 10 is a proximity sensor.

When the protection device of this embodiment is used, if a foreign matter appears on the return conveyor belt 3, the foreign matter barrier plate 5, the rotation shaft 4 and the hammer arm 8 are driven to rotate, the hammer arm rotating around the rotation shaft 4 to get close and trigger the triggering sensor 10.

### Embodiment 3

As a different between this embodiment and embodiment 2, to prevent a hammer arm 8 from excessively divert and mount a triggering sensor 10, a rotation triggering mechanism further includes a sensor holder 11 configured to fix the triggering sensor 10 and limit a rotation angle of the hammer arm 8, the triggering sensor 10 being arranged on the sensor holder 11.

In this embodiment, the sensor holder 11 is in an L shape.

The hammer arm 8 rotates around the rotation shaft 4 by a certain angle to abut against the sensor holder 11 when the device is used.

### Embodiment 4

As a different between this embodiment and embodiments 1, 2 and 3, a protection device in this embodiment is arranged close to a bent pulley 1, and the protection device further includes a material accumulation plate, a bottom of the material accumulation plate being fixedly connected to a rotation shaft 4.

Since a foreign matter barrier plate 5 and a return conveyor belt 3 are arranged at an interval, a material, which may directly pass through the foreign matter barrier plate 5 and nay not trigger operation of a triggering sensor 10, on the return conveyor belt 3 may pass through the foreign matter barrier plate 5 to enter a bent pulley 1 and then be thrown, by the bent pulley 1, to the return conveyor belt 3, which is repeatedly accumulated influencing operation of the belt conveyor.

The material accumulation plate is arranged in such way, the material thrown out by the bent pulley 1 may impact on the material accumulation plate, then fall down along the material accumulation plate, and enter the bent pulley 1 to be thrown out again. When the material is accumulated to a certain quantity, after the material thrown out by the bent pulley 1 impacts the material accumulation plate, the material accumulation plate and the rotation shaft 4 are driven to rotate, and a rotation triggering mechanism is driven to operate as well.

To improve the material accumulation effect of the material accumulation plate, the material accumulation plate includes a tilt plate 12 and a vertical plate 13, the tilt plate 12 being arranged titled to the bent pulley 1, a bottom of the tilt plate 12 being fixedly connected to a top of the rotation shaft 4, a top of the tilt plate 12 being fixedly connected to a bottom of the vertical plate 13, and a top of the vertical plate 13 and the going conveyor belt 2 being arranged at an interval. Through such structure, the vertical plate 13 is made to get closer to the bent pulley 1, so as to make the material thrown out by the bent pulley 1 to be blocked by the material accumulation plate. A gap between the joint of the vertical plate and the tilt plate and the surface of a pulley body of the bent pulley is 3-5 cm.

Similar to embodiment 1, in order to prevent the conveyor belt shakes during operation to come into contact with the foreign matter barrier plate 5, prevent the protection device from influencing the conveyor belt, and improve sensing sensitivity of the material and special-shaped articles thrown out by the material accumulation plate by the material accumulation plate, a gap between a top of the material accumulation plate and the going conveyor belt 2 is 2-3 cm.

In this embodiment, as shown in FIG. 1, a side surface of a body of a mechanical limit block 6 is a vertical surface, another side surface is a tilt surface, an area of a top surface is small, and the material falling from the material accumulation plate is prevented from being accumulated on the mechanical limit block 6.

An existing belt conveyor faces lots of problems: during operation of the belt conveyor, a conveyor belt may be torn and deviate, so as to cause conveyed materials to fall on the return conveyor belt 3. Although a tail of the conveyor is equipped with a cleaning device, the cleaning device is aimed at the case of a small quantity of materials on the return conveyor belt 3, and may not effectively clean a large quantity of materials or various foreign matters appearing on the return conveyor belt 3, such that these materials and foreign matters are conveyed to the tail of the conveyor by the return conveyor belt 3, and finally roll into the position between the bent pulley 1 of the tail and the conveyor belt. The rolled-into materials or foreign matters rotate upwards around an axis of the pulley along with the bent pulley 1 under the action of the rotating bent pulley 1 and the conveyor belt. When the materials are rotated to a position above the bent pulley 1, the going conveyor belt 2 of the belt conveyor leaves the bent pulley 1, the materials or the foreign matters are not clamped any longer, are thrown out in a tangential direction of a surface of the pulley, and may fall on the return conveyor belt 3 to be conveyed again, by the return conveyor belt 3, to the bent pulley 1 of the tail and therefore may roll into the position between the belt and the pulley, which is performed in cycles. Since the rolled-into materials and foreign materials are irregular in shape, the conveyor belt is extremely prone to deviate. In addition, after the materials roll into the above position, a rotation radius of the conveyor belt is increased, the conveyor belt violently squeezes and rubs against the frame or other parts of the belt conveyor, so as to cause the conveyor belt or the parts of the belt conveyor to be damaged and the belt conveyor to be incapable of normally conveying materials any longer. Metal articles rolled into the pulley at the tail of the belt conveyor may directly cause the conveyor belt or the parts to be damaged. In addition, an abnormal state of the conveyor belt may be detected by detecting a large quantity of materials on the return conveyor belt. The tail of the belt conveyor is provided with a material falling pipe, a coal guide groove, a material receiving bed, etc. the apparatuses are arranged relatively densely, workers may often work at such position accordingly due to various reasons, so a personal injury accident caused by worker rolling into and clamped by the position between the bent pulley 1 of the tail and the conveyor belt is frequent. The existing belt conveyor may have the above abnormal conditions, so as to cause damage to the apparatus and personal injuries.

A particular principle of the protection device during operation in this embodiment is:

When large-sized foreign matters or a large quantity of conveyed materials, fallen belt conveyor parts and various sundries including the worker fall on the return conveyor belt 3, the foreign matters are conveyed on the return conveyor belt 3 and impact against the foreign matter barrier plate 5 when passing through a return belt cleaner, so as to drive the rotation shaft 4 and the hammer arm 8 to rotate, the hammer arm 8 gets close to and triggers the triggering sensor 10, the belt conveyor stops, and the mechanical limit block 6 may prevent the matters from entering the bent pulley 1 due to inertia after stop.

When small-sized foreign matters or a small quantity of conveyed materials pass through the foreign matter barrier plate 5 and are conveyed back and forth between the bent pulley 1 and the conveyor belt, the bent pulley 1 throws the small-sized foreign matters out, if the small-sized foreign matters are relatively large in mass, or the small-sized foreign matters is relatively small in mass, but has the characteristic of accumulation, that is, the foreign matters impact on the material accumulation plate and fall down, the foreign matters may re-enter the bent pulley 1 and are thrown out, after accumulated to a certain quantity, the small-sized foreign matters impact on the material accumulation plate so as to enable the material accumulation plate to drive the rotation shaft 4 and the hammer arm 8 to rotate, the hammer arm 8 gets close to and trigger the triggering sensor 10, and the belt conveyor stops, so as to prevent or avoid damage to the apparatus and personal injuries.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A protection device for a belt conveyor, the belt conveyor comprising a frame, a transmission roller, a bent pulley and a conveyor belt sleeved on the transmission roller and the bent pulley, a conveyor belt located at a bottom of the bent pulley being a return conveyor belt, and a conveyor belt located at a top of the bent pulley being a going conveyor belt), characterized in that the protection device is arranged on the return conveyor belt, the protection device comprises a rotation shaft, a foreign matter barrier plate and a rotation triggering mechanism, the rotation shaft being fixedly connected to the frame of the belt conveyor, the foreign matter barrier plate being vertically arranged, a top of the foreign matter barrier plate being fixedly connected to the rotation shaft, a bottom of the foreign matter barrier plate and the return conveyor belt being arranged at an interval, the rotation triggering mechanism being fixedly connected to the rotation shaft, and the foreign matter barrier plate driving the rotation shaft to rotate, and driving the rotation triggering mechanism to operate when the device is used.

2. The protection device for the belt conveyor of claim 1, wherein the protection device further comprises a mechanical limit block configured to limit a rotation angle of the foreign matter barrier plate, the mechanical limit block being fixedly connected to the frame of the belt conveyor, the mechanical limit block being arranged on the return conveyor belt, and the foreign matter barrier plate rotating around the rotation shaft to abut against the mechanical limit block when the device is used.

3. The protection device for the belt conveyor of claim 1, wherein the rotation triggering mechanism further comprises a hammer block, a hammer arm, a hammer frame and a triggering sensor, one end of the hammer arm being fixedly connected to the rotation shaft, the other end being fixedly connected to the hammer block, the hammer frame and the triggering sensor being fixedly connected to the frame of the belt conveyor, a bottom of the hammer arm abutting against the hammer frame, and the hammer arm rotating around the rotation shaft and triggering the triggering sensor when the device is used.

4. The protection device for the belt conveyor of claim 3, wherein the rotation triggering mechanism further comprises a sensor holder configured to fix the triggering sensor and limit a rotation angle of the hammer arm, the triggering sensor being arranged on the sensor holder, and the hammer arm rotating around the rotation shaft and abutting against the sensor holder when the device is used.

5. The protection device for the belt conveyor of claim 3, wherein the triggering sensor is a proximity sensor.

6. The protection device for the belt conveyor of claim 1, wherein the protection device is arranged close to the bent pulley, and the protection device further comprises a material accumulation plate, a bottom of the material accumulation plate being fixedly connected to the rotation shaft.

7. The protection device for the belt conveyor of claim 6, wherein the material accumulation plate comprises a tilt plate and a vertical plate, the tilt plate being arranged titled to the bent pulley, a bottom of the tilt plate being fixedly connected to a top of the rotation shaft, a top of the tilt plate being fixedly connected to a bottom of the vertical plate, and a top of the vertical plate and the going conveyor belt being arranged at an interval.

8. The protection device for the belt conveyor of claim 1, wherein the rotation shaft comprises a rotation shaft body, two rotation bearings and two bearing supports, the bearing support being fixedly arranged on the frame of the belt conveyor, the rotation bearing being fixedly arranged on the bearing support, and two ends of the rotation shaft body being rotatably connected to the two rotation bearings separately.

9. The protection device for the belt conveyor of claim 1, wherein a gap between the bottom of the foreign matter barrier plate and the return conveyor belt is 2-3 cm.

10. The protection device for the belt conveyor of claim 6, wherein a gap between the top of a material accumulation plate and the going conveyor belt is 2-3 cm.
